(19) United States
(12) Patent Application Publication
(10) Pub. No.: US 2010/0182363 A1
(43) Pub. Date: Jul. 22, 2010

(54) LIQUID DISCHARGING APPARATUS AND CONTROL METHOD THEREOF

(75) Inventor: Kinya Ozawa, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/691,690

(22) Filed: Jan. 21, 2010

(30) Foreign Application Priority Data
Jan. 22, 2009 (JP) 2009-011526

(51) Int. Cl. B41J 29/38

(52) U.S. Cl. 347/11

(57) ABSTRACT

A liquid discharging apparatus includes: a liquid discharging head which has a pressure generation chamber that is communicated with a nozzle orifice, and a pressure generation element that generates pressure variation in liquid in the pressure generation chamber, and which can discharge liquid from the nozzle orifice by the operation of the pressure generation element; and a driving signal generation section which generates a series of driving signals that includes a driving pulse which drives the pressure generation element, wherein the driving pulse which the driving signal generation section generates includes an expansion element which expands the pressure generation chamber, thereby drawing in the meniscus, a contraction element which varies voltage so as to contract the expanded pressure generation chamber, a re-expansion element which re-expands the pressure generation chamber after the contraction by the contraction element, thereby drawing in the meniscus, and a re-contraction element which varies voltage so as to contract the re-expanded pressure generation chamber, and the re-contraction element includes a first re-contraction element, and a second re-contraction element which contracts the re-expanded pressure generation chamber at a different rate of voltage change from that of the first re-contraction element.

### BACKGROUND

1. Technical Field

The present invention relates to a liquid discharging apparatus such as an ink jet type printer and a control method thereof, and in particular, to a liquid discharging apparatus provided with a liquid discharging head which discharges liquid in a pressure generation chamber from a nozzle orifice by creating pressure variation in the pressure generation chamber which is communicated with the nozzle orifice, and a control method thereof.

2. Related Art

A liquid discharging apparatus is an apparatus which is provided with a liquid discharging head capable of discharging liquid and discharges a variety of liquid from the liquid discharging head. As a representative example of the liquid discharging apparatus, an image recording apparatus such as an ink jet type printer (hereinafter simply referred to as a printer) which is provided with an ink jet type recording head (hereinafter simply referred to as a recording head) as a liquid discharging head and performs the recording of an image or the like by discharging and landing ink in the form of liquid from nozzles of the recording head on a recording medium (landing object) such as a recording paper can be given. Further, in recent years, a liquid discharging apparatus is applied not only to an image recording apparatus, but also to various manufacturing apparatuses such as an apparatus for manufacturing a color filter of a liquid crystal display or the like.

As the above-mentioned liquid discharging apparatus, there is a liquid discharging apparatus constituted so as to create pressure change to liquid in a pressure generation chamber by driving a pressure generation element (for example, a piezoelectric vibrator, heat generation element, or the like) by the application of a driving pulse (discharge pulse) to the pressure generation element and discharge liquid from a nozzle communicated with the pressure generation chamber by using the pressure change. In such a liquid discharging apparatus, by increasing the amplitude of pressure vibration which is given to the liquid in the pressure generation chamber, it is possible to increase the amount of liquid which is discharged. In other words, by increasing the driving voltage of a discharge driving pulse, it is possible to increase the amount of liquid which is discharged (for example, refers to JP-A-2003-94656).

In recent years, in a liquid discharging apparatus, there are made attempts to discharge liquid (hereinafter also referred to as high-viscosity liquid) with higher viscosity than liquid which has been used in the past, such as UV ink (ultraviolet cure type ink), for example. That is, in the past, an object to be discharged was a liquid with a low viscosity, such as water, but, in recent years, there have been attempts made to discharge high-viscosity liquids having viscosity of 8 mPa·s or more. In order to obtain a sufficient discharge amount when discharging a high-viscosity liquid, it is necessary to create pressure change of a magnitude according to the discharge amount of liquid in the pressure generation chamber. However, if pressure change is increased, the discharge velocity of liquid also becomes higher, so that a phenomenon tends to easily occur in which the rear end portion of the liquid extends like a tail. Then, there is the fear that the tail portion will separate and fly from the main body of the liquid droplet, so that it will not land on a normal position (desired position) on the landing object. For example, in an ink jet printer, the tail portion becomes mist and lands deviated from the normal position, so that the dot is divided, and therefore, a problem occurs in that image quality deteriorates. In particular, in high-viscosity liquid, the tail portion divides into several portions, and these divided portions (satellite ink droplets or mist) cause significant lowering of image quality.

On the other hand, if amount of pressure change generated on the liquid in the pressure generation chamber is smaller than first pressure change, when the tail portion of the high-viscosity liquid in the nozzle orifice starts to be separated from the meniscus, a phenomenon occurs in which the tail portion that is not discharged and remains on the meniscus side is drawn into the pressure generation chamber side, so that the length of the tail portion cut from the meniscus is shortened. At this time, since the tail portion is cut during extension, there is a case where residual vibration of the meniscus is excited due to retroaction of the cutting. Thus, if the tail portion remaining on the meniscus side is conglomerated and separated, there is a problem in that the separated portion is incidentally discharged.

### SUMMARY

An advantage of some aspects of the invention is that it provides a liquid discharging apparatus in which in the case of discharging a high-viscosity liquid, the generation of mist or the like is suppressed, so that the separation of a dot can be prevented, and a control method thereof.

According to a first aspect of the invention, there is provided a liquid discharging apparatus including: a liquid discharging head which has a pressure generation chamber that is communicated with a nozzle orifice, and a pressure generation element that generates pressure variation in a liquid in the pressure generation chamber, and which can discharge liquid from the nozzle orifice by the operation of the pressure generation element; and a driving signal generation section which generates a series of driving signals that includes a driving pulse which drives the pressure generation element, wherein the driving pulse which the driving signal generation section generates includes an expansion element which expands the pressure generation chamber, thereby drawing in the meniscus, a contraction element which varies voltage so as to contract the expanded pressure generation chamber, a re-expansion element which re-expands the pressure generation chamber after the contraction by the contraction element, thereby drawing in the meniscus, and a re-contraction element which varies voltage so as to contract the re-expanded pressure generation chamber, and the re-contraction element includes a first re-contraction element, and a second re-contraction element which contracts the re-expanded pressure generation chamber at a different rate of voltage change from that of the first re-contraction element.

According to this configuration, since the driving pulse that the driving signal generation section generates includes an expansion element which expands the pressure generation chamber, thereby drawing in the meniscus, a contraction element which varies voltage so as to contract the expanded pressure generation chamber, thereby discharging a liquid droplet, a re-expansion element which re-expands the pressure generation chamber after the contraction element, thereby drawing in the meniscus, and a re-contraction element which varies voltage so as to contract the re-expanded pressure generation chamber, and the re-contraction element includes a first re-contraction element, and a second re-contraction element which contracts the re-expanded pressure generation chamber at a different rate of voltage change from that of the first re-contraction element, when discharging a liquid with relatively high viscosity (high-viscosity liquid), a phenomenon in which the rear end portion of the discharged liquid extends like a tail can be suppressed compared to the case of supplying the re-contraction element at a constant rate of voltage change, so that it is possible to make a shape of the rear end portion as close to a globular shape as possible. Further, residual vibration of the meniscus after the discharging of an ink droplet is suppressed, so that a columnar portion remaining on the meniscus side rounds, whereby it can be suppressed that the portion is incidentally discharged as a small ink droplet. As a result, the liquid can be prevented from being divided into a plurality of droplets and landing on a landing object.

In the above-described configuration, it is preferable that the rate of voltage change of the second re-contraction element be set to be smaller than the rate of voltage change of the first re-contraction element.

According to above-described configuration, since the rate of voltage change of the second re-contraction element is set to be smaller than the rate of voltage change of the first re-contraction element, the pressure generation chamber is rapidly contracted by the first re-contraction element, so that the meniscus is rapidly drawn to the pressure generation chamber side, whereby it can be suppressed that the rear end portion of the discharged liquid extends like a tail. In addition, the pressure generation chamber is gently contracted by the second re-contraction element, so that it can be suppressed that the tail portion remaining on the meniscus side out of the meniscus after the discharging of liquid rounds and is discharged.

In the above-described configuration, it is preferable that the amount of voltage change of the re-expansion element be set to be equal to or greater than 30% of the difference in potential between the lowest voltage and the highest voltage of the driving pulse.

According to above-described configuration, since the amount of voltage change of the re-expansion element is set to be equal to or greater than 30% of the difference in potential between the lowest voltage and the highest voltage of the driving pulse, the meniscus is reliably drawn to the pressure generation chamber side when re-expanding the contracted pressure generation chamber, so that the growing of a tail attached to liquid which is discharged can be suppressed, whereby in the case of discharging a high-viscosity liquid, the generation of mist or the like is suppressed, and thus the separation of dots can be prevented.

In the above-described configuration, it is preferable that the re-expansion element include a first re-expansion element, and a second re-expansion element which re-expands the pressure generation chamber at a different rate of voltage change from that of the first re-contraction element, and at least the amount of voltage change of the second re-expansion element be set to be equal to or greater than 30% of the difference in potential between the lowest voltage and the highest voltage of the driving pulse.

According to above-described configuration, since the re-expansion element includes a first re-expansion element, and a second re-expansion element which re-expands the pressure generation chamber at a different rate of voltage change from that of the first re-contraction element, and at least the amount of voltage change of the second re-expansion element is set to be equal to or greater than 30% of the difference in potential between the lowest voltage and the highest voltage of the driving pulse, compared to the case of supplying the re-expansion element at a constant rate of voltage change, the rear end portion of the discharged liquid can be drawn to the pressure generation chamber side, so that a phenomenon in which the rear end portion of the discharged liquid extends like a tail can be suppressed.

In the above-described configuration, it is preferable that between the re-expansion element and the first re-contraction element, a re-expansion hold element which holds voltage for a certain period of time at the rear end of the re-expansion element be provided, and the supply time of the re-expansion hold element and the first re-contraction element be set to be equal to or greater than ⅓ of an inherent vibration period Tc of the liquid filled in the pressure generation chamber.

According to above-described configuration, since between the re-expansion element and the first re-contraction element, a re-expansion hold element which holds voltage for a certain period of time at the rear end of the re-expansion element is provided, and the supply time of the re-expansion hold element and the first re-contraction element is set to be equal to or greater than ⅓ of an inherent vibration period Tc of the liquid filled in the pressure generation chamber, the stability of the meniscus can be secured, and thus, compared to the case of supplying the re-contraction element at a constant rate of voltage change, a time width of the supply time of the re-expansion hold element and the first re-contraction element can be widened. Therefore, it becomes possible to increase the degree of freedom of waveform design.

In the above-described configuration, it is preferable that the supply time of the second re-contraction element be set to be equal to or less than an inherent vibration period Tc of the liquid filled in the pressure generation chamber.

According to the above-described configuration, since the supply time of the second re-contraction element is set to be equal to or less than an inherent vibration period Tc of the liquid filled in the pressure generation chamber, the excitation of the meniscus by the discharging of liquid can be suppressed, so that a phenomenon can be further suppressed in which the rear end portion of the discharged liquid extends like a tail.

In the above-described configuration, it is preferable that between the first re-contraction element and the second re-contraction element, a re-contraction hold element which holds voltage for a certain period of time at the rear end of the first re-contraction element be provided.

According to the above-described configuration, since between the first re-contraction element and the second re-contraction element, a re-contraction hold element which holds voltage for a certain period of time at the rear end of the first re-contraction element is provided, residual vibration of the meniscus by the first re-contraction element can be suppressed.

According to a second aspect of the invention, there is provided a control method of a liquid discharging apparatus provided with a liquid discharging head which has a pressure generation chamber that is communicated with a nozzle orifice, and a pressure generation element that generates pressure variation in liquid in the pressure generation chamber, and which can discharge liquid from the nozzle orifice by the operation of the pressure generation element; and a driving signal generation section which generates a series of driving signals that includes a driving pulse which drives the pressure generation element, the method including: an expansion process of expanding the pressure generation chamber, thereby drawing in the meniscus; a contraction process of varying voltage so as to contract the pressure generation chamber expanded in the expansion process; a re-expansion process of re-expanding the pressure generation chamber after the contraction process, thereby drawing in the meniscus; and a re-contraction process of varying voltage so as to contract the pressure generation chamber re-expanded in the re-expansion process, wherein the re-contraction process includes a first re-contraction process, and a second re-contraction process of contracting the re-expanded pressure generation chamber at a different rate of voltage change from that in the first re-contraction process.

### BRIEF DESCRIPTION OF THE DRAWINGS

The invention will be described with reference to the accompanying drawings, wherein like numbers reference like elements.

FIG. 1 is a block diagram explaining the electrical configuration of a printer.

FIG. 2 is a cross-sectional view of a principal section explaining the configuration of a recording head.

FIG. 3 is a waveform diagram explaining the configuration of a middle-size dot discharge pulse.

FIGS. 4A to 4D are views showing the movement of the meniscus when discharging an ink droplet.

FIG. 5 is a table showing the results of an experiment which observes the discharge stability of an ink droplet.

FIG. 6 is a table showing the results of another experiment which observes the discharge stability of an ink droplet.

FIG. 7 is a waveform diagram explaining the configuration of a small dot discharge pulse.

FIG. 8 is a waveform diagram explaining a modified example of the small dot discharge pulse.

FIG. 9 is a waveform diagram explaining the configuration of a middle-size dot discharge pulse in a second embodiment.

### DESCRIPTION OF EXEMPLARY EMBODIMENTS

Hereinafter, the best mode for carrying out the invention will be explained with reference to the accompanying drawings. Further, although in embodiments described below, various limitations are given as the preferred specific examples of the invention, unless the description of intent to limit the invention is particularly given in the following explanation, the scope of the invention is not to be limited to these aspects. In addition, in the following description, as a liquid discharging apparatus of the invention, an ink jet type recording apparatus (hereinafter referred to as a printer) is taken and explained as example.

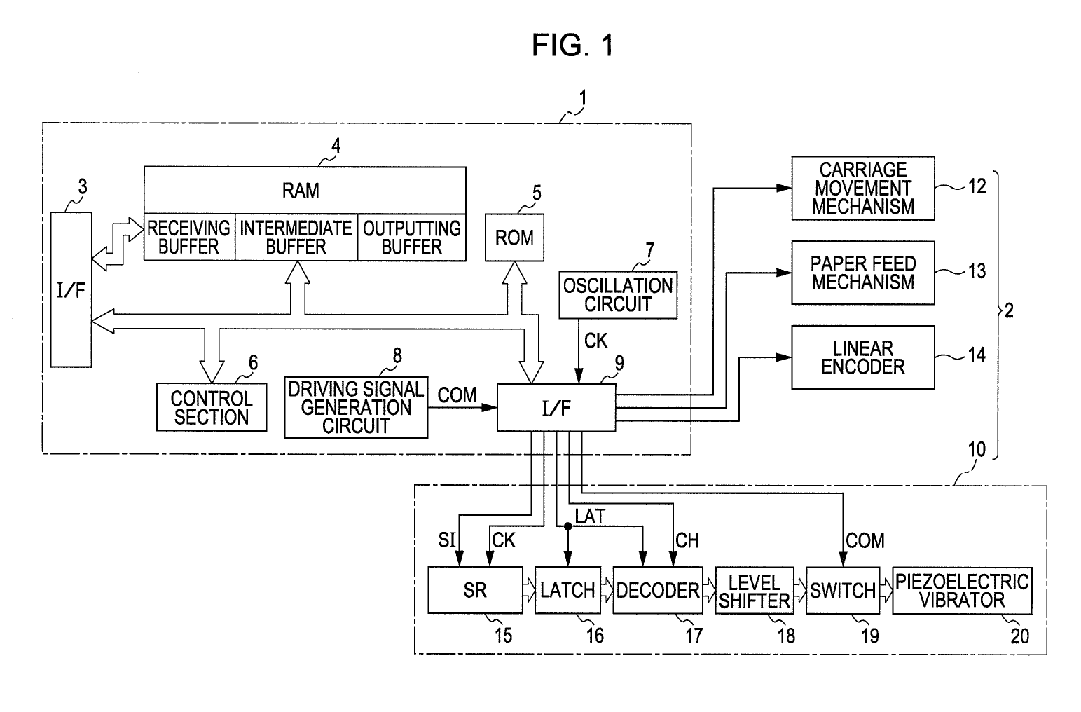

FIG. 1 is a block diagram showing the electrical configuration of a printer. The printer is generally constituted of a printer controller 1 and a print engine 2. The printer controller 1 includes an external interface (external I/F) 3 which performs the delivery and receipt of data between the printer controller and an external apparatus such as a host computer, a RAM 4 which stores various data and so on, a ROM 5 in which a control routine and so on for various data processing are stored, a control section 6 which performs the control of each section, an oscillation circuit 7 which generates a clock signal, a driving signal generation circuit 8 which generates a driving signal to be supplied to a recording head 10, and an internal interface (internal I/F) 9 for outputting dot pattern data, the driving signal, or the like to the recording head 10.

The control section 6 not only performs the control of each section, but also converts print data received from the external apparatus through the external I/F 3 into dot pattern data and outputs the dot pattern data to the recording head 10 side through the internal I/F 9. The dot pattern data is constituted of the printing data which is obtained by decoding (interpreting) gradation data. Further, the control section 6 supplies a latch signal, a channel signal, or the like to the recording head 10 on the basis of the clock signal from the oscillation circuit 7. Latch pulse or channel pulse, which is included in the latch signal or the channel signal, prescribes supply timing of each pulse constituting the driving signal.

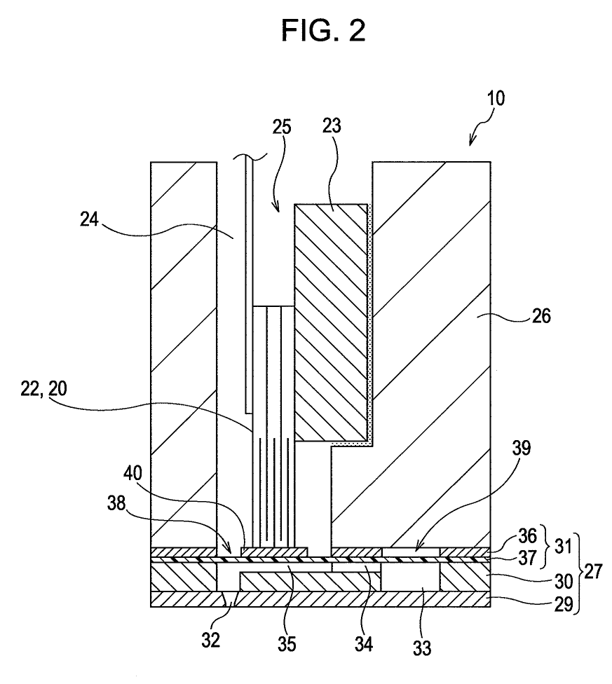

The driving signal generation circuit 8 is controlled by the control section 6 and generates a driving signal for driving a piezoelectric vibrator 20 (refers to FIG. 2). The driving signal generation circuit 8 in this embodiment is configured to generate a driving signal COM which includes a discharge pulse for discharging an ink droplet (a kind of a liquid droplet), thereby forming a dot on a recording paper, which is a kind of a discharge object, a minute vibration pulse for minutely vibrating a free surface, namely, the meniscus, of ink (a kind of liquid) exposed to a nozzle orifice 32 (refers to FIG. 2), thereby agitating the ink, or the like within one recording period.

Next, the configuration of the print engine 2 side is explained. The print engine 2 is constituted of the recording head 10, a carriage movement mechanism 12, a paper feed mechanism 13, and a linear encoder 14. The recording head 10 is provided with a shift register (SR) 15, a latch 16, a decoder 17, a level shifter 18, a switch 19, and the piezoelectric vibrator 20. The dot pattern data (Si) from the printer controller 1 is serial-transmitted to the shift register 15 in synchronization with a clock signal (CK) from the oscillation circuit 7. The dot pattern data is 2-bit data and is constituted of gradation information which represents a recordation gradation (discharge gradation) of 4 gradations composed of, for example, non-recordation (minute vibration), a small dot, a middle-size dot, a large dot. Specifically, non-recordation is represented by gradation information “00”; a small dot, gradation information “01”; a middle-size dot, gradation information “10”; a large dot, gradation information “11”.

To the shift register 15, the latch 16 is electrically connected, and if a latch signal (LAT) from the printer controller 1 is input to the latch 16, the latch latches the dot pattern data of the shift register 15. The dot pattern data latched by the latch 16 is input to the decoder 17. The decoder 17 interprets 2-bit dot pattern data, thereby generating pulse selection data. The pulse selection data is constituted by relating each bit to each pulse which constitutes the driving signal COM. Then, supply or non-supply of the discharge pulse to the piezoelectric vibrator 20 is selected in accordance with the content of each bit, for example, “0” or “1”.

Then, the decoder 17 outputs the pulse selection data to the level shifter 18 with the receipt of the latch signal (LAT) or the channel signal (CH) as a chance. In this case, the pulse selection data is input to the level shifter 18 in sequence from a higher-order bit. The level shifter 18 functions as a voltage amplifier and outputs an electric signal boosted to voltage capable of driving the switch 19, for example, voltage of the order of several tens of volts, in a case where the pulse selection data is “1”. The pulse selection data of “1” boosted in the level shifter 18 is supplied to the switch 19. To the input side of the switch 19, the driving signal COM from the driving signal generation circuit 8 is supplied, and to the output side of the switch 19, the piezoelectric vibrator 20 is connected.

Then, the pulse selection data controls the operation of the switch 19, that is, the supply of the driving pulse of the driving signal to the piezoelectric vibrator 20. For example, during a period when the pulse selection data which is input to the switch 19 is “1”, the switch 19 enters a connected state, so that a corresponding discharge pulse is supplied to the piezoelectric vibrator 20, and an electrical potential level of the piezoelectric vibrator 20 varies in accordance with a waveform of the discharge pulse. On the other hand, during a period when the pulse selection data is “0”, an electric signal for operating the switch 19 is not outputted from the level shifter 18. Therefore, the switch 19 enters a disconnected state, so that the discharge pulse is not supplied to the piezoelectric vibrator 20.

The decoder 17, the level shifter 18, the switch 19, the control section 6, and the driving signal generation circuit 8, which perform such operation, function as a driving section in the invention and select a necessary discharge pulse out of the driving signal on the basis of the dot pattern data, thereby applying (supplying) it to the piezoelectric vibrator 20. As a result, the piezoelectric vibrator 20 extends or contracts, and a pressure generation chamber 35 (refers to FIG. 2) expands or contracts in accordance with the extension or the contraction of the piezoelectric vibrator 20, so that an ink droplet of the amount according to the gradation information constituting the dot pattern data is discharged from the nozzle orifice 32.

FIG. 2 is a cross-sectional view of a principal section of the recording head 10 described above. The recording head 10 in this embodiment is constituted to have a vibrator unit 25 which is unitized with a piezoelectric vibrator group 22, a stationary plate 23, a flexible cable 24, and so on, a head case 26 which can accommodate the vibrator unit 25, and a flow path unit 27 which forms a successive ink flow path (liquid flow path) reaching from a common ink chamber (common liquid chamber) through the pressure generation chamber 35 to the nozzle orifice 32.

First, the vibrator unit 25 is explained. The piezoelectric vibrators 20 (a kind of pressure generation element in the invention) constituting the piezoelectric vibrator group 22 are formed into a tooth-comb shape being elongated in a longitudinal direction, and carved into a very thin width on the order of several tens of μm. Also, the piezoelectric vibrator 20 is configured as a longitudinal oscillation type piezoelectric vibrator capable of extending or contracting in a longitudinal direction. Each piezoelectric vibrator 20 is fixed in the state of a so-called cantilever beam with a fixed end portion joined to the stationary plate 23 and a free-end portion protruding further outward than the leading end edge of the stationary plate 23. Also, the leading end of the free-end portion of each piezoelectric vibrator 20 is joined to an island portion 40 which constitutes a diaphragm portion 38 of the flow path unit 27, as described later. The flexible cable 24 is electrically connected to the piezoelectric vibrator 20 on the side of the fixed end portion, which is the opposite side to the stationary plate 23. Further the stationary plate 23 which supports each piezoelectric vibrator 20 is constituted of a metallic plate material having rigidity capable of bearing the reactive force from the piezoelectric vibrator 20.

Next, the flow path unit 27 is explained. The flow path unit 27 is constituted of a nozzle plate 29, a flow path formation substrate 30, and a vibration plate 31, and is constituted by disposing the nozzle plate 29 on one side surface of the flow path formation substrate 30 and the vibration plate 31 on the other side surface of the flow path formation substrate 30, which becomes the opposite side to the nozzle plate 29, so as to form a lamination, and then integrating them by adhesion or the like. The nozzle plate 29 is a thin plate made of stainless steel, in which a plurality of nozzle orifices 32 are opened and provided in a row shape at a pitch corresponding to dot formation density. In this embodiment, for example, 180 nozzle orifices 32 are opened and provided in a row shape, and these nozzle orifices 32 constitutes a nozzle row (nozzle group). Further, two nozzle rows are arranged in juxtaposition. In addition, the nozzle orifice 32 of this embodiment is composed of a straight portion which is disposed on the opposite side (discharge face side) to the pressure generation chamber 35 of the nozzle plate 29 joined to the flow path formation substrate 30, and an enlarged-diameter portion whose diameter becomes larger as it goes from the straight portion to the pressure generation chamber 35 side.

The flow path formation substrate 30 is a plate-like member which forms a successive ink flow path (a kind of liquid flow path) composed of a reservoir 33, an ink supply port 34, and the pressure generation chamber 35. Specifically, the flow path formation substrate 30 is a plate-like member in which a space portion that becomes the pressure generation chamber 35 is formed in a plurality of numbers partitioned by partition walls correspondingly to each nozzle orifice 32, and also, space portions that become the ink supply port 34 and the reservoir 33 are formed. Further, the flow path formation substrate 30 of this embodiment is manufactured by etching a silicon wafer. The pressure generation chamber 35 is formed as a chamber being elongated in a direction orthogonal to the row direction (nozzle row direction) of the nozzle orifices 32, and the ink supply port 34 is formed as a narrowed portion with a narrow flow path width connecting between the pressure generation chamber 35 and the reservoir 33. Also, the reservoir 33 is a chamber for supplying ink stored in an ink cartridge (not shown) to each pressure generation chamber 35 and is communicated with a corresponding pressure generation chamber 35 through the ink supply port 34.

The vibration plate 31 is a composite plate material of a double structure in which a resin film 37 such as PPS (polyphenylene sulfide) is laminated on a support plate 36 made of metal such as stainless steel, and is a member which has the diaphragm portion 38 for sealing an opening face of one side of the pressure generation chamber 35 and changing the volume of the pressure generation chamber 35 and in which a compliance portion 39 that seals an opening face of one side of the reservoir 33 is formed. Further, the diaphragm portion 38 is constituted by forming the island portion 40 for joining the leading end of the free-end portion of the piezoelectric vibrator 20, by performing etching on the support plate 36 so as to annularly remove a portion corresponding to the pressure generation chamber 35. The island portion 40 is of a block shape being elongated in a direction orthogonal to the row direction of the nozzle orifices 32, similarly to the planar shape of the pressure generation chamber 35, and the resin film 37 around the island portion 40 functions as an elastic film. Further, a portion serving as the compliance portion 39, that is, a portion corresponding to the reservoir 33 is composed of only the resin film 37 as the support plate 36 is removed in accordance with the opening shape of the reservoir 33 by etching.

In the recording head 10 having the above-described configuration, by deforming the piezoelectric vibrator 20, a corresponding pressure generation chamber 35 contracts or expands, so that pressure variation occurs in the ink in the pressure generation chamber 35. By controlling the ink pressure, ink (ink droplet) can be discharged from the nozzle orifice 32. If the pressure generation chamber 35 having a steady volume is preliminarily expanded prior to the discharge of ink, ink is supplied from the reservoir 33 side into the pressure generation chamber 35 through the ink supply port 34. Also, if the pressure generation chamber 35 is rapidly contracted after the preliminary expansion, ink is discharged from the nozzle orifice 32.

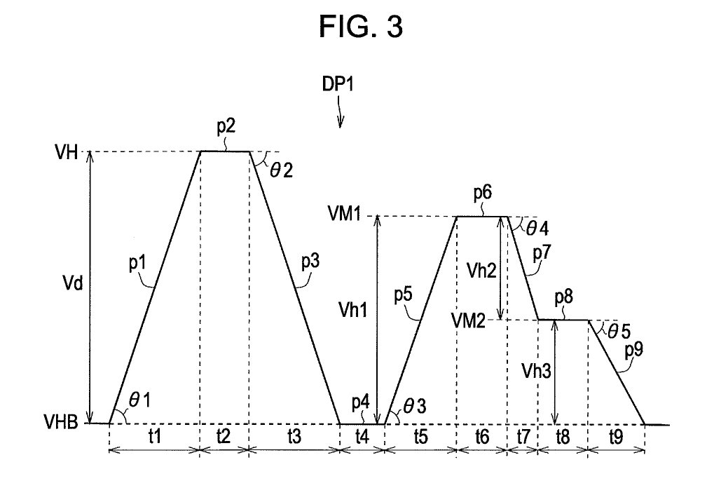

FIG. 3 is a waveform diagram explaining the configuration of a discharge pulse DP1 which is included in the driving signal COM that the driving signal generation circuit 8 having the above-described configuration generates. The illustrated discharge pulse DP1 is a middle-size dot discharge pulse for discharging an ink droplet (middle-size dot) of an intermediate size between an ink droplet being smallest in size and an ink droplet being largest in size, out of ink droplets which can be discharged in the printer 1 of this embodiment. The middle-size dot discharge pulse DP1 is constituted of a first expansion element p1 (corresponding to an expansion element in the invention) which increases electrical potential from reference potential (the lowest potential) VHB up to the highest potential VH at a certain gradient (rate of voltage change) θ1, a first hold element p2 which holds the highest potential VH being the rear end potential of the first expansion element p1 for a short period of time, a first contraction element p3 (corresponding to a contraction element in the invention) which lowers electrical potential from the highest potential VH up to the reference potential VHB at a certain gradient θ2 (θ1≈θ2), a second hold element p4 which holds the reference potential VHB for a short period of time, a re-expansion element p5 which increases electrical potential from the reference potential VHB up to a first intermediate potential VM1 at a certain gradient (rate of voltage change) θ3, a re-expansion hold element p6 which holds the first intermediate potential VM1 being the rear end potential of the re-expansion element p5 for a certain period of time, a first re-contraction element p7 which lowers electrical potential up to a second intermediate potential VM2 at a relatively steep, certain gradient θ4, a re-contraction hold element p8 which holds the second intermediate potential VM2 for a short period of time, and a second re-contraction element p9 which lowers electrical potential from the second intermediate potential VM2 up to the reference potential VHB at a certain gradient θ5 (θ5<θ4). Further, the gradient θ2 of the first contraction element p3 may not be equal to the gradient θ1 of the first expansion element p1.

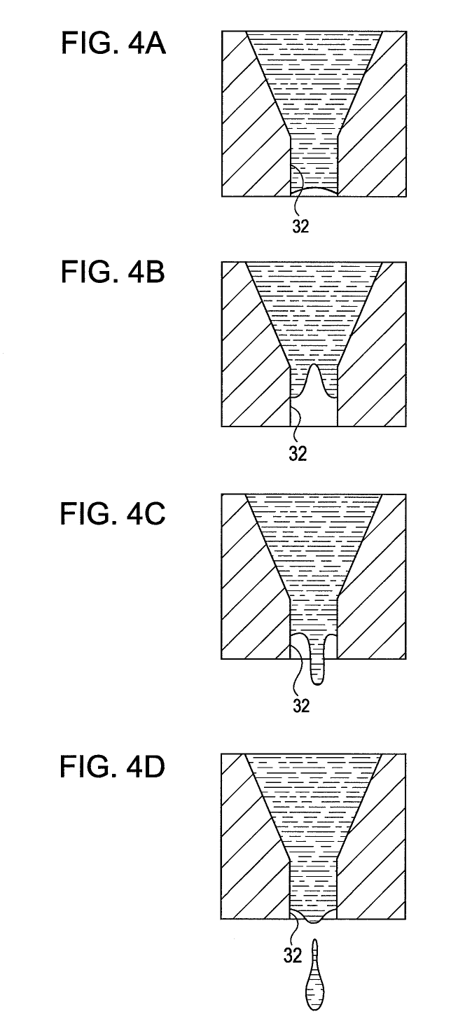

If the middle-size dot discharge pulse DP1 is supplied to the piezoelectric vibrator 20, the following actions occur. First, if the first expansion element p1 is supplied to the piezoelectric vibrator 20, the piezoelectric vibrator 20 contacts in a longitudinal direction thereof, so that the pressure generation chamber 35 expands from reference volume corresponding to the reference potential VHB up to a volume corresponding to the highest potential VH (expansion process). By this expansion process, the meniscus being in a state shown in FIG. 4A is largely drawn to the pressure generation chamber 35 side, as shown in FIG. 4B, and also, ink is supplied from the reservoir 33 side into the pressure generation chamber 35 through the ink supply port 34. Then, the expansion state of the pressure generation chamber 35 in the expansion process is constantly maintained over a supply period t2 of the first hold element p2 (expansion holding process).

Thereafter, as the first contraction element p3 is supplied to the piezoelectric vibrator 20, the piezoelectric vibrator 20 extends, so that the pressure generation chamber 35 contracts from the volume corresponding to the highest potential VH up to the volume corresponding to the reference potential VHB (contraction process). By the contraction of the pressure generation chamber 35, the ink in the pressure generation chamber 35 is pressurized, so that the central portion of the meniscus is extruded to a discharge side (the opposite side to the pressure generation chamber 35), as shown in FIG. 4C. This is because the central portion of the meniscus easily moves compared to the edge portion (a side near to the inner circumference of the nozzle orifice 32) of the meniscus, thereby easily following pressure variation. Subsequently, the second hold element p4 is supplied, so that discharge volume is maintained for a brief period of time t4. Subsequently, the piezoelectric vibrator 20 is contacted by the re-expansion element p5, so that the pressure generation chamber 35 re-expands from the volume corresponding to the reference potential VHB up to a volume corresponding to the first intermediate potential VM1 (re-expansion process). Then, the re-expansion state of the pressure generation chamber 35 in the re-expansion process is constantly maintained over supply time t6 of the re-expansion hold element p6 (re-expansion holding process). The amount of voltage change, Vh1, of the re-expansion element p5 is set to be smaller than the difference in potential between the reference voltage VHB and the highest voltage VH, that is, the driving voltage Vd of the middle-size dot discharge pulse DP1. In this way, also during supply periods t7 to t9 from the first re-contraction element p7, which contract the re-expanded pressure generation chamber 35, to the second re-contraction element p9, it is suppressed that pressure variation when re-contracting the pressure generation chamber 35 is excited in the meniscus, so that it is suppressed that an ink droplet is separated from the meniscus which performs residual vibration after the discharging of an ink droplet and discharged as mist or the like.

Thereafter, as the first re-contraction element p7 is supplied to the piezoelectric vibrator 20, the piezoelectric vibrator 20 extends again, so that the pressure generation chamber 35 rapidly contracts from a volume corresponding to the first intermediate potential VM1 up to a volume corresponding to the second intermediate potential VM2 (first re-contraction process). Due to the rapid contraction of the pressure generation chamber 35, the ink in the pressure generation chamber 35 is pressurized, so that the central portion of the meniscus in the enlarged-diameter portion of the nozzle orifice 32 swells in a columnar shape.

Subsequently, the re-contraction hold element p8 is supplied to the piezoelectric vibrator 20, so that the second intermediate potential VM2 is maintained for a certain period of time t8 (re-contraction holding process). Also, the contraction state of the pressure generation chamber 35 is maintained for a certain period of time over the supply period of the re-contraction hold element p8. During the supply period of the re-contraction hold element p8, as shown in FIG. 4D, the columnar central portion of the meniscus is cut on the way, and then the leading end side portion thereof is discharged from the nozzle orifice 32 as an ink droplet corresponding to a middle-size dot. Further, by supplying the re-contraction hold element p8, a difference in phase between the center side and the outer edge side of the meniscus can be suppressed, so that it is suppressed that the portion remaining on the meniscus side of the columnar central portion rounds and is discharged as a small ink droplet (mist ink).

Thereafter, as the second re-contraction element p9 is supplied to the piezoelectric vibrator 20, the piezoelectric vibrator 20 further extends, so that the pressure generation chamber 35 contracts and returns more gently than in the first re-contraction process, from the volume corresponding to the second intermediate potential VM2 up to the volume corresponding to the reference potential VHB (second re-contraction process). Here, the gradient θ5 from the second intermediate potential VM2 up to the reference potential VHB is set to be smaller (more gentle) than the gradient θ4 from the first intermediate potential VM1 up to the second intermediate potential VM2. In this way, the pressure generation chamber 35 is rapidly contracted by the first re-contraction element p7, so that the meniscus is rapidly drawn to the pressure generation chamber side, whereby a phenomenon can be suppressed in which the rear end portion of the discharged columnar ink extends like a tail. In addition, the pressure generation chamber 35 is gently contacted by the second re-contraction element p9, so that residual vibration of the meniscus after the discharging of ink can be suppressed.

In addition, in this embodiment, by optimizing waveform elements of the middle-size dot discharge pulse DP1, the residual vibration after the discharging of an ink droplet is suppressed, so that an ink droplet is stably discharged. Specifically, in the middle-size dot discharge pulse DP1, the amount of voltage change, Vh1, of the re-expansion element p5 is set to be equal to or greater than 30% of the difference in potential between the reference potential VHB and the highest voltage VH of the middle-size dot discharge pulse DP1, and in addition, the supply time t6+t7 of the re-expansion hold element p6 and the first re-contraction element p7 is set to be equal to or greater than ⅓ of an inherent vibration period Tc of the ink filled in the pressure generation chamber 35.

With regard to the amount of voltage change, Vh1, of the re-expansion element p5, as described above, by setting it to be smaller than the difference in potential between the reference potential VHB and the highest voltage VH of the middle-size dot discharge pulse DP1, it is suppressed that pressure variation when re-contracting the pressure generation chamber 35 is excited in the meniscus. On the contrary, if the amount of voltage change, Vh1, is set to be smaller without limit, there is a fear that the rear end of a columnar ink droplet swollen from the meniscus remains extended like a tail and the tail portion will separate and fly from the main body of the ink droplet. Therefore, in order to maintain the discharge stability of an ink droplet, it is necessary to set the amount of voltage change, Vh1, within a certain range.

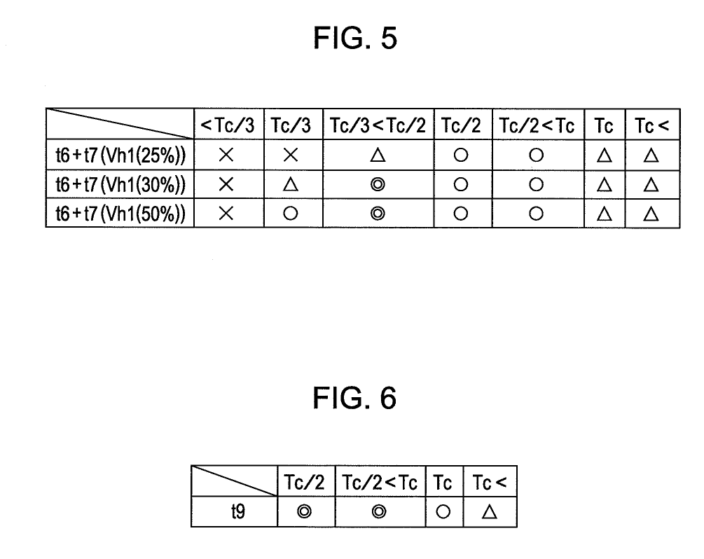

FIG. 5 is a table showing the results of an experiment which observes the discharge stability of an ink droplet by varying the supply time t6+t7 from the re-expansion hold element p6 to the first re-contraction element p7 in the middle-size dot discharge pulse DP1. Further, in this experiment, the amount of voltage change, Vh1, of the re-expansion element p5 is set to be 25% of the difference in potential between the reference potential VHB and the highest voltage VH of the middle-size dot discharge pulse DP1, 30% of the difference in potential between the reference potential VHB and the highest voltage VH of the middle-size dot discharge pulse DP1, and 50% of the difference in potential between the reference potential VHB and the highest voltage VH of the middle-size dot discharge pulse DP1, respectively. On the other hand, the discharge stability of an ink droplet varies in accordance with the state of the meniscus at discharge timing, specifically, the position or the movement velocity of the meniscus. A period of pressure vibration generated by expanding the pressure generation chamber 35 by the first expansion element p1 which excites pressure vibration on the ink in the pressure generation chamber 35 is called an inherent vibration period Tc of the pressure generation chamber 35, which is determined for every recording head 10, and the state of the meniscus depends on pressure vibration which is excited in the ink in the pressure generation chamber 35. That is, in accordance with the inherent vibration period Tc, the meniscus vibrates and the flying velocity of ink varies. In addition, with respect to the discharge stability of an ink droplet, an ink droplet which is actually discharged, or mist ink which is incidentally generated from the meniscus that performs residual vibration after the discharging of the ink droplet is observed, then, a case where mist ink flies is shown as a symbol of x, a case where tail extension of an ink droplet is reduced is shown as a symbol of Δ, a case where allowable discharge stability can be secured is shown as a symbol of o, and a case where stability is excellent is shown as a symbol of ©.

First, looking at a case where the amount of voltage change, Vh1, of the re-expansion element p5 is set to be 25% of the difference in potential between the reference potential VHB and the highest voltage VH of the middle-size dot discharge pulse DP1, it can be found that if the supply time t6+t7 of the re-expansion hold element p6 and the first re-contraction element p7 is not equal to or greater than ½ of the inherent vibration period Tc, stable discharge cannot be performed. On the contrary, in a case where the amount of voltage change, Vh1, of the re-expansion element p5 is set to be 30% of the difference in potential between the reference potential VHB and the highest voltage VH of the middle-size dot discharge pulse DP1, it can be found that if the supply time t6+t7 of the re-expansion hold element p6 and the first re-contraction element p7 is set to be larger than at least ⅓ of the inherent vibration period Tc, discharge stability can be obtained. Similarly, in a case where the amount of voltage change, Vh1, of the re-expansion element p5 is set to be 50% of the difference in potential between the reference potential VHB and the highest voltage VH of the middle-size dot discharge pulse DP1, it can be found that if the supply time t6+t7 of the re-expansion hold element p6 and the first re-contraction element p7 is set to be equal to or greater than ⅓ of the inherent vibration period Tc, discharge stability can be obtained.

From the above, it was found that when the amount of voltage change, Vh1, of the re-expansion element p5 is equal to or greater than 30% of the difference in potential between the reference potential VHB and the highest voltage VH of the middle-size dot discharge pulse DP1, and in addition, the supply time t6+t7 of the re-expansion hold element p6 and the first re-contraction element p7 is set to be equal to or greater than ⅓ of the inherent vibration period Tc, reduction of tail extension of an ink droplet and discharge stability can be obtained while a time width of the entire waveform of the middle-size dot discharge pulse DP1 is minimized.

Further, FIG. 6 is a table showing the results of an experiment which observes the discharge stability of an ink droplet by varying the supply time t9 of the second re-contraction element p9 of the middle-size dot discharge pulse DP1. As described above, in a period which supplies the second re-contraction element p9, the discharged ink droplet is separated from the meniscus of the ink in the nozzle orifice 32, and a state occurs where residual vibration is excited in the meniscus in accordance with the discharging. Therefore, in order to suppress the residual vibration of the meniscus, it is necessary to further contract the pressure generation chamber 35 than the contraction of the pressure generation chamber 35 by the first re-contraction element p7, by supplying the second re-contraction element p9. In addition, in FIG. 6, a case where tail extension of an ink droplet is reduced is shown as a symbol of Δ, a case where allowable discharge stability can be secured is shown as a symbol of o, and a case where stability is excellent is shown as a symbol of ©.

From the results shown in FIG. 6, it can be found that when the supply time t9 of the second re-contraction element p9 of the middle-size dot discharge pulse DP1 is set to be shorter than the inherent vibration period Tc, residual vibration of the meniscus can be suppressed. Therefore, it was found that by setting the supply time of the second re-contraction element to be equal to or less than the inherent vibration period Tc, the pressure generation chamber 35 is gently contracted by the second re-contraction element p9, so that residual vibration of the meniscus after the discharging of ink can be suppressed.

By adopting the configuration as explained above, for example, in the case of discharging ink (high-viscosity liquid) being higher in viscosity than prior ink, as in a light cured type of ink which is cured by the irradiation of light energy such as ultraviolet rays, when re-contracting the re-expanded pressure generation chamber 35, by supplying the first re-contraction element p7 set as a rate of change of the gradient θ4, and the second re-contraction element p9 set as the gradient θ5 which is smaller in rate of change than the gradient θ4 of the first re-contraction element p7, a phenomenon in which the rear end portion of the discharged ink droplet extends like a tail can be suppressed compared to the case of supplying the re-contraction element at a constant rate of voltage change, so that it is possible to make a shape of the rear end portion as close to a globular shape as possible. Further, residual vibration of the meniscus after the discharging of an ink droplet is suppressed, so that the remaining portion of a columnar central portion remaining on the meniscus side rounds, whereby it can be suppressed that the portion is further separated and discharged as a small ink droplet (mist ink). As a result, liquid can be prevented from being divided into a plurality of droplets and landing on a landing object.

On the other hand, the invention is not to be limited to the above-described embodiment, but various modifications can be made based on the description of the appended claims.

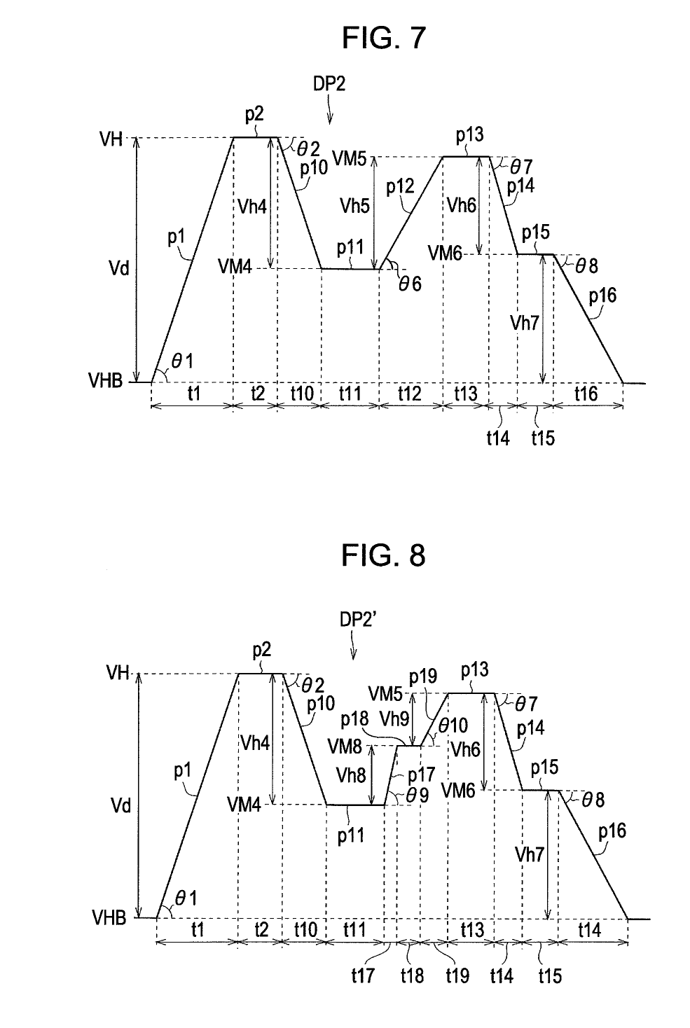

FIG. 7 is a waveform diagram showing a small dot discharge pulse DP2. Although in the above-described embodiment, as one example of the discharge pulse in the invention, a middle-size dot discharge pulse DP1 was explained, a shape of a discharge pulse is not limited to this. For example, a small dot discharge pulse DP2 shown in FIG. 7 is constituted of the first expansion element p1, the first hold element p2, a first contraction element p10 in this pulse, which lowers electrical potential from the highest potential VH up to a fourth intermediate potential VM4 at a certain gradient θ2, a second hold element p11 in this pulse, which holds the fourth intermediate potential VM4 being the rear end potential of the first contraction element p10 for a certain period of time, a re-expansion element p12 which increases electrical potential from the fourth intermediate potential VM4 up to a fifth intermediate potential VM5 at a certain gradient (rate of voltage change) 06, a re-expansion hold element p13 which holds the fifth intermediate potential VM5 being the rear end potential of the re-expansion element p12 for a certain period of time, a first re-contraction element p14 which lowers electrical potential up to a sixth intermediate potential VM6 at a relatively steep, certain gradient θ7, a re-contraction hold element p15 which holds the sixth intermediate potential VM6 for a short period of time, and a second re-contraction element p16 which lowers electrical potential from the sixth intermediate potential VM6 up to the reference potential VHB at a certain gradient θ8 (θ8<θ7).

If the small dot discharge pulse DP2 is supplied to the piezoelectric vibrator 20, the columnar central portion of the meniscus becomes thinner than the case of supplying the middle-size dot discharge pulse DP1, so that the leading end side portion cut on the way out of the columnar central portion is discharged from the nozzle orifice 32 as an ink droplet corresponding to a small dot.

FIG. 8 is a waveform diagram showing a modified example of the small dot discharge pulse. In the small dot discharge pulse DP2′ of this example, the re-expansion element p12 of the above-described small dot discharge pulse DP2 is constituted of a first re-expansion element p17 which increases electrical potential from the fourth intermediate potential VM4 up to an eighth intermediate potential VM8 at a certain gradient (rate of voltage change) 09, a re-expansion intermediate hold element p18 which holds the eighth intermediate potential VM8 being the rear end potential of the first re-expansion element p17 for a certain period of time, and a second re-expansion element p19 which increases electrical potential from the eighth intermediate potential VM8 up to the fifth intermediate potential VM5 at a certain gradient θ10 (θ10<θ9). In addition, the sum (Vh8+Vh9) of a rate of voltage change, Vh8, of the first re-expansion element p17 and a rate of voltage change, Vh9, of the second re-expansion element p19 is set to be equal to or greater than 30% of the difference in potential between the reference potential VHB and the highest voltage VH of the small dot discharge pulse DP2′.

If the small-dot discharge pulse DP2′ is supplied to the piezoelectric vibrator 20, a difference in phase between the center side and the outer edge side of the meniscus can be further suppressed than the case of supplying the small dot discharge pulse DP2, so that the portion of the columnar central portion, which remained on the meniscus side, rounds, whereby it is suppressed that the portion is extra discharged as a small ink droplet.

Further, as for the discharge pulse DP, a pulse of any waveform can be used provided that it is a discharge pulse constituted to include at least the first re-contraction element p7 or p14 and the second re-contraction element p9 or p16 having a different rate of change from the first re-contraction element p7 or p14.

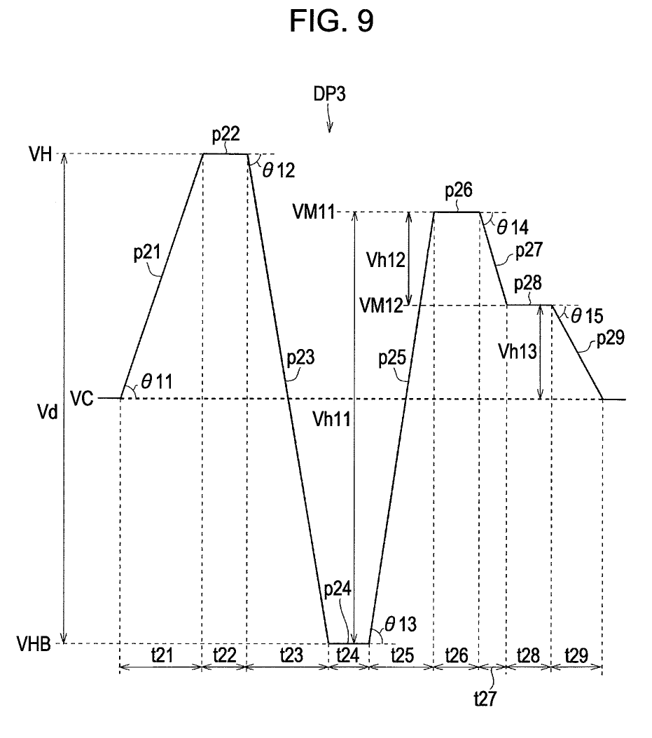

For example, with respect to the middle-size dot discharge pulse DP1, as in a second embodiment shown in FIG. 9, a driving pulse may also be adopted in which an intermediate potential VC corresponding to an intermediate volume of the pressure generation chamber 35 is used as a start potential and an end potential. The middle-size dot discharge pulse DP3 of this embodiment is constituted of a first expansion element p21 which increases electrical potential from the intermediate potential VC (reference potential) corresponding to an intermediate volume (volume which becomes a reference for expansion or contraction) of the pressure generation chamber 35 up to an expansion potential VH at a certain gradient θ11, a first hold element p22 which holds the expansion potential VH for a short period of time, a first contraction element p23 which lowers electrical potential from the expansion potential VH up to a contraction potential VHB at a steep gradient θ12 (θ12>θ11), a second hold element p24 which holds the contraction potential VHB for a short period of time, a re-expansion element p25 which increases electrical potential from the contraction potential VHB up to an eleventh intermediate potential VM11 at a steep gradient θ13 (θ12≈θ13), a re-expansion hold element p26 which is constant with the eleventh intermediate potential VM11, a first re-contraction element p27 which lowers electrical potential up to a twelfth intermediate potential VM12 at a relatively steep, certain gradient θ14 which is the extent that does not discharge ink, a re-contraction hold element p28 which holds the twelfth intermediate potential VM12 for a short period of time, and a second re-contraction element p29 which returns electrical potential from the second intermediate potential VM12 up to the intermediate potential VC at a certain gradient θ15 (θ15<θ14) which is the extent that does not discharge ink.

Also in the second embodiment, when re-contracting the re-expanded pressure generation chamber 35, by supplying the first re-contraction element p27 set as a rate of change of the gradient θ14, and the second re-contraction element p29 set as the gradient θ15 which is smaller in rate of change than the gradient θ14 of the first re-contraction element p2′7, a phenomenon in which the rear end portion of the discharged ink droplet extends like a tail can be suppressed compared to the case of supplying the re-contraction element at a constant rate of voltage change. Therefore, in the case of discharging high-viscosity ink, the generation of mist or the like is suppressed, so that it becomes possible to prevent the separation of a dot.

Also, although in the above-described embodiments, as a pressure generation element, the piezoelectric vibrator 20 of a so-called longitudinal oscillation mode was illustrated, the pressure generation element is not limited to this. For example, also in the case of using a piezoelectric vibrator of a so-called deflection oscillation mode, it is possible to apply the invention. In addition, in the case of adopting the piezoelectric vibrator of a deflection oscillation mode, the waveforms of the discharge pulses DP1, DP2, DP2′, and DP3 shown in FIGS. 3, 7, 8, and 9 are turned upside down.

In addition, provided that it is a liquid discharging apparatus in which discharge control can be performed by using a plurality of driving signals, the invention is not limited to a printer, but can be applied to various ink jet type recording apparatus such as a plotter, a facsimile apparatus, and a copy machine, or liquid discharging apparatuses other than a recording apparatus, for example, a display manufacturing apparatus, an electrode manufacturing apparatus, a chip manufacturing apparatus, and the like.

The entire disclosure of Japanese Patent Application No. 2009-011526, filed Jan. 22, 2009 is expressly incorporated by reference herein.

What is claimed is:

1. A liquid discharging apparatus comprising:
a liquid discharging head which has a pressure generation chamber that is communicated with a nozzle orifice, and a pressure generation element that generates pressure variation in a liquid in the pressure generation chamber, and which can discharge liquid from the nozzle orifice by the operation of the pressure generation element; and
a driving signal generation section which generates a series of driving signals that includes a driving pulse which drives the pressure generation element,
wherein the driving pulse which the driving signal generation section generates includes an expansion element which expands the pressure generation chamber, thereby drawing in the meniscus, a contraction element which varies voltage so as to contract the expanded pressure generation chamber, a re-expansion element which re-expands the pressure generation chamber after the contraction by the contraction element, thereby drawing in the meniscus, and a re-contraction element which varies voltage so as to contract the re-expanded pressure generation chamber, and
the re-contraction element includes a first re-contraction element, and a second re-contraction element which contracts the re-expanded pressure generation chamber at a different rate of voltage change from that of the first re-contraction element.

2. The liquid discharging apparatus according to claim 1, wherein the rate of voltage change of the second re-contraction element is set to be smaller than the rate of voltage change of the first re-contraction element.

3. The liquid discharging apparatus according to claim 1, wherein the amount of voltage change of the re-expansion element is set to be equal to or greater than 30% of the difference in potential between the lowest voltage and the highest voltage of the driving pulse.

4. The liquid discharging apparatus according to claim 1, wherein the re-expansion element includes a first re-expansion element, and a second re-expansion element which re-expands the pressure generation chamber at a different rate of voltage change from that of the first re-contraction element, and
at least the amount of voltage change of the second re-expansion element is set to be equal to or greater than 30% of the difference in potential between the lowest voltage and the highest voltage of the driving pulse.

5. The liquid discharging apparatus according to claim 1, wherein between the re-expansion element and the first re-contraction element, a re-expansion hold element which holds voltage for a certain period of time at the rear end of the re-expansion element is provided, and
the supply time of the re-expansion hold element and the first re-contraction element is set to be equal to or greater than ⅓ of an inherent vibration period Tc of the liquid filled in the pressure generation chamber.

6. The liquid discharging apparatus according to claim 1, wherein the supply time of the second re-contraction element is set to be equal to or less than an inherent vibration period Tc of the liquid filled in the pressure generation chamber.

7. The liquid discharging apparatus according to claim 1, wherein between the first re-contraction element and the second re-contraction element, a re-contraction hold element which holds voltage for a certain period of time at the rear end of the first re-contraction element is provided.

8. A control method of a liquid discharging apparatus provided with a liquid discharging head which has a pressure generation chamber that is communicated with a nozzle orifice, and a pressure generation element that generates pressure variation in a liquid in the pressure generation chamber, and which can discharge liquid from the nozzle orifice by the operation of the pressure generation element;
and a driving signal generation section which generates a series of driving signals that includes a driving pulse which drives the pressure generation element,
the method comprising:
an expansion process of expanding the pressure generation chamber, thereby drawing in the meniscus;
a contraction process of varying voltage so as to contract the pressure generation chamber expanded in the expansion process;
a re-expansion process of re-expanding the pressure generation chamber after the contraction process, thereby drawing in the meniscus; and
a re-contraction process of varying voltage so as to contract the pressure generation chamber re-expanded in the re-expansion process,
wherein the re-contraction process includes a first re-contraction process, and a second re-contraction process of contracting the re-expanded pressure generation chamber at a different rate of voltage change from that in the first re-contraction process.
